(19) United States
(12) Patent Application Publication
(10) Pub. No.: US 2026/0023728 A1
(43) Pub. Date: Jan. 22, 2026

(54) DATA CLEANING METHOD AND APPARATUS FOR BLOCKCHAIN, COMPUTER DEVICE, AND STORAGE MEDIUM

(71) Applicant: TENCENT TECHNOLOGY (SHENZHEN) COMPANY LIMITED, Shenzhen (CN)

(72) Inventors: Zhuguang SHAO, Shenzhen (CN); Li LI, Shenzhen (CN); Min WANG, Shenzhen (CN); Jianjun ZHANG, Shenzhen (CN); Bing SHAO, Shenzhen (CN); Bengbeng SU, Shenzhen (CN)

(21) Appl. No.: 19/340,148

(22) Filed: Sep. 25, 2025

Related U.S. Application Data
(63) Continuation of application No. PCT/CN2023/124724, filed on Oct. 16, 2023.

(30) Foreign Application Priority Data
Jul. 26, 2023 (CN) 202310930289.6

(51) Int. Cl. G06F 16/215; G06F 16/23

(52) U.S. Cl. CPC G06F 16/215; G06F 16/2379

(57) ABSTRACT

A data cleaning method performed by a computer device includes in response to a new block being generated in a blockchain including a first node maintained by the computer and a second node, obtaining a transaction deadline tree maintained by the first node, and determining an expired transaction task in the transaction deadline tree, extracting one or more target transaction tasks from a transaction pool of the blockchain, generating a proposal message of the new block that carries transaction identification information of the expired transaction task based on the expired transaction task and the one or more target transaction tasks, and broadcasting the proposal message to the second node to cause the second node to perform consensus on the new block based on the one or more target transaction tasks and clean the expired transaction task based on the transaction identification information after consensus is reached.

### CROSS-REFERENCE TO RELATED APPLICATIONS

This application is a continuation of International Application No. PCT/CN2023/124724, filed on Oct. 16, 2023, which claims priority to Chinese Patent Application No. 2023109302896, filed with the China National Intellectual Property Administration on Jul. 26, 2023, and entitled “DATA CLEANING METHOD AND APPARATUS FOR BLOCKCHAIN, COMPUTER DEVICE, AND STORAGE MEDIUM,” the entire contents of both of which are incorporated herein by reference.

### FIELD OF THE TECHNOLOGY

This application relates to the field of computer technologies, and in particular, to a data cleaning method and apparatus for a blockchain, a computer device, a storage medium, and a computer program product.

### BACKGROUND OF THE DISCLOSURE

A blockchain is a new decentralized distributed ledger technology that can securely store transactions or other data, and is characterized in that information stored in the blockchain cannot be forged and tampered with. A blockchain consensus algorithm drives each node in the blockchain to participate in a transaction verification process, to ensure that all transactions in the blockchain are confirmed to be trusted. Essentially, a blockchain is a distributed storage system. Each node of the blockchain can store data, and the node stores data based on data. As a data volume increases, more and more data needs to be stored. Certainly, for some non-distributed data, performance of the blockchain gets lower and lower. Since the blockchain has distributed storage itself, each node usually uses a non-distributed database, and natural performance may be affected. Therefore, expired data needs to be cleaned.

However, currently data cleaning for the blockchain is as follows: an administrator of a blockchain system sends a command to nodes of an entire blockchain (the command is also sent to the blockchain in a transaction manner), where the command usually specifies a data filing height, and the nodes of the blockchain file (clean) all transaction data before the data filing height, thereby reducing a data volume. However, this process requires manual intervention. To be specific, in a case that a large amount of data is stored in the blockchain, the foregoing data cleaning mode requires manual participation, and the data cleaning mode is a single-point behavior. To be specific, for the entire blockchain system, after data in a node is manually cleaned, a subsequent processing procedure of another service may be affected, or execution states of the nodes may be inconsistent, thereby causing a security problem in the entire blockchain subjected to data cleaning.

### SUMMARY

In accordance with the disclosure, there is provided a data cleaning method performed by a computer device and including in response to a new block being generated in a blockchain including a first node maintained by the computer and a second node, obtaining a transaction deadline tree maintained by the first node, and determining an expired transaction task in the transaction deadline tree, extracting one or more target transaction tasks from a transaction pool of the blockchain, generating a proposal message of the new block that carries transaction identification information of the expired transaction task based on the expired transaction task and the one or more target transaction tasks, and broadcasting the proposal message to the second node to cause the second node to perform consensus on the new block based on the one or more target transaction tasks and clean the expired transaction task based on the transaction identification information after consensus is reached.

Also in accordance with the disclosure, there is provided a computer device including a memory storing computer-readable instructions, and a processor configured to execute the computer-readable instructions to, in response to a new block being generated in a blockchain including a first node maintained by the computer and a second node, obtain a transaction deadline tree maintained by the first node, and determine an expired transaction task in the transaction deadline tree, extract one or more target transaction tasks from a transaction pool of the blockchain, generate a proposal message of the new block that carries transaction identification information of the expired transaction task based on the expired transaction task and the one or more target transaction tasks, and broadcast the proposal message to the second node to cause the second node to perform consensus on the new block based on the one or more target transaction tasks and clean the expired transaction task based on the transaction identification information after consensus is reached.

Also in accordance with the disclosure, there is provided a non-transitory computer-readable storage medium storing computer-readable instructions that, when executed by a processor, cause a computer having the processor to, in response to a new block being generated in a blockchain including a first node maintained by the computer and a second node, obtain a transaction deadline tree maintained by the first node, and determine an expired transaction task in the transaction deadline tree, extract one or more target transaction tasks from a transaction pool of the blockchain, generate a proposal message of the new block that carries transaction identification information of the expired transaction task based on the expired transaction task and the one or more target transaction tasks, and broadcast the proposal message to the second node to cause the second node to perform consensus on the new block based on the one or more target transaction tasks and clean the expired transaction task based on the transaction identification information after consensus is reached.

### BRIEF DESCRIPTION OF THE DRAWINGS

To describe the technical solutions in the embodiments of this application more clearly, the following briefly describes the accompanying drawings needed for describing the embodiments. Apparently, the accompanying drawings in the following descriptions show merely some embodiments of this application, and a person of ordinary skill in the art may still derive other drawings from the disclosed accompanying drawings without creative efforts.

FIG. 1 is a schematic diagram of an optional structure of a distributed system applied to a blockchain system according to an embodiment.

FIG. 2 is an optional schematic diagram of a block structure according to an embodiment.

FIG. 3 is a flowchart of a data cleaning method for a blockchain according to an embodiment.

FIG. 4 is a schematic structural diagram of a transaction deadline tree according to an embodiment.

FIG. 5 is a schematic diagram showing a proposing process of a primary node according to an embodiment.

FIG. 6 is a schematic diagram showing information carried in a transaction task according to an embodiment.

FIG. 7 is a schematic diagram showing a process of creating a transaction deadline tree according to an embodiment.

FIG. 8 is a schematic diagram showing information carried in a proposal message according to an embodiment.

FIG. 9 is a schematic diagram showing a verification process after receiving a proposal message from a node according to an embodiment.

FIG. 10 is a consensus flowchart of a byzantine fault tolerance (BFT) consensus algorithm according to an embodiment.

FIG. 11 is a flowchart of cleaning of expired data according to an embodiment.

FIG. 12 is a schematic diagram showing data cleaning.

FIG. 13 is a structural block diagram of a data cleaning apparatus for a blockchain according to an embodiment.

FIG. 14 is a diagram showing an internal structure of a computer device according to an embodiment.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

Here, the terms, involved in the following description, “first, second, and third” are merely intended to distinguish similar objects rather than describing specific orders. “First, second, and third” is interchangeable in proper circumstances to enable the embodiments of this application to be implemented in other orders than those illustrated or described herein.

A system involved in the embodiments of the present disclosure may be a distributed system including a client and a plurality of nodes. The plurality of nodes and the nodes and the client may communicate with each other through a network. The nodes may be maintained by a server or a user terminal. To be specific, functional modules of the nodes may be deployed on the server or the user terminal, and the server or the user terminal implements functions of the nodes.

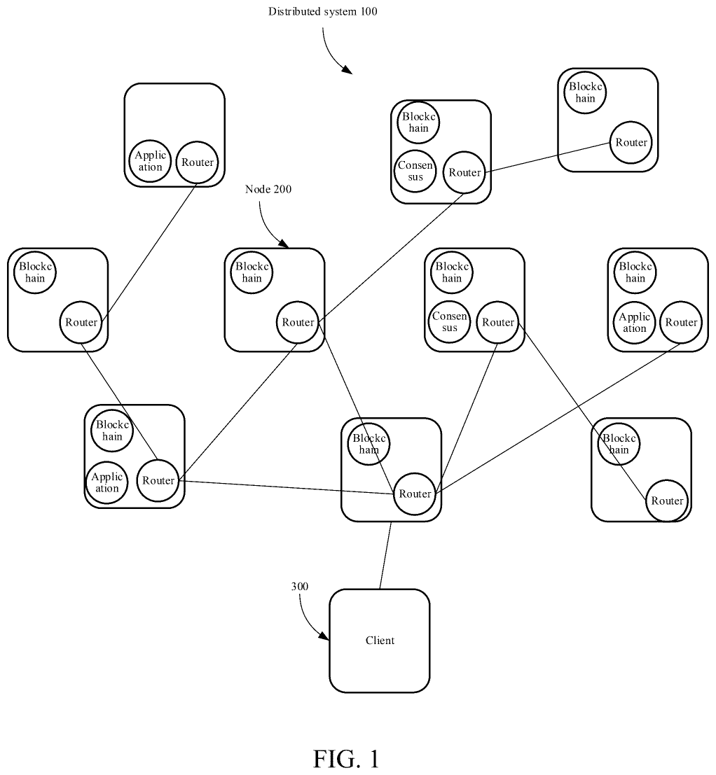

The distributed system serving as a blockchain system is taken as an example. FIG. 1 is a schematic diagram of an optional structure of a distributed system 100 applied to a blockchain system according to an embodiment of the present disclosure. A plurality of nodes and a client are included. A peer to peer network is formed between the nodes. A Peer To Peer protocol is an application layer protocol run on a transmission control protocol (TCP). In the distributed system, any machine such as a server or a terminal may be added to form a new node which includes a hardware layer, an intermediate layer, an operating system layer, and an application layer.

Referring to functions of the nodes in the blockchain system shown in FIG. 1, the functions involved include:

1) Routing: Routing is a basic function of a node and is configured for supporting communications between the nodes.

In addition to the routing function, the node may further have the following functions:

2) Application: An application is configured for being deployed in a blockchain, implementing a particular service according to an actual service requirement, recording data related to function implementation to form recorded data, adding a digital signature to the recorded data to represent a source of task data, and transmitting the recorded data to other nodes in the blockchain system, so that the recorded data is added to a temporary block when verification performed by another node on a source and integrity of the recorded data succeeds.

For example, services implemented by the application include:

2.1) Wallet: A wallet is configured for providing a function for electronic money transaction, including transaction initiation. To be specific, a transaction record of a current transaction is transmitted to another node in the blockchain system. After the verification performed by the another node succeeds, in response to admitting that the transaction is valid, recorded data of the transaction is stored into a temporary block of the blockchain. Certainly, the wallet also supports querying for remaining electronic money in an electronic money address.

2.2) Shared ledger: A shared ledger is configured for providing functions of operations such as storage, query, modification of account data, and transmitting recorded data of the operations on the account data to another node in the blockchain system. The another node stores, after verifying that the account data is valid, recorded data into a temporary block in response to admitting that the account data is valid, and may further transmit an acknowledgement to a node initiating the operations.

2.3) Smart contract: A smart contract is a computerized protocol, which can execute terms and conditions of a contract and is implemented by using codes that are deployed in a shared ledger and that are executed when a condition is satisfied. The codes are configured for completing an automated transaction according to an actual service need, for example, querying a logistics state of a commodity purchased by a buyer and transferring electronic money of the buyer to an address of a merchant after the buyer signs for the commodity. Certainly, the smart contract is not limited to a contract for executing a transaction, but may alternatively be a contract for processing received information.

3) Blockchain: A blockchain includes a series of blocks that are consecutive in a sequence of generation time. Once a new block is added into the blockchain, the new block is no longer removed. The block records recorded data submitted by a node in the blockchain system.

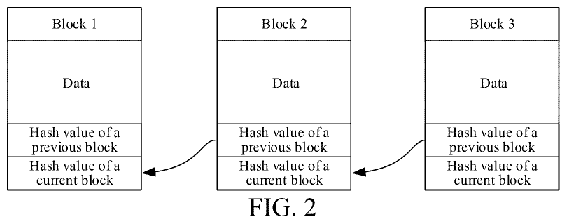

FIG. 2 is an optional schematic diagram of a block structure according to an embodiment of the present disclosure. Each block includes a hash value of a transaction record stored in this block (a hash value of this block) and a hash value of a previous block. Blocks are connected through the hash values to form a blockchain. In addition, the block may further include information such as a timestamp in case of block generation. The blockchain is essentially a decentralized database and is a string of data blocks generated through association by using a cryptographic method. Each data block includes relevant information for verifying validity (anti-counterfeiting) of information of the data block and generating a next block.

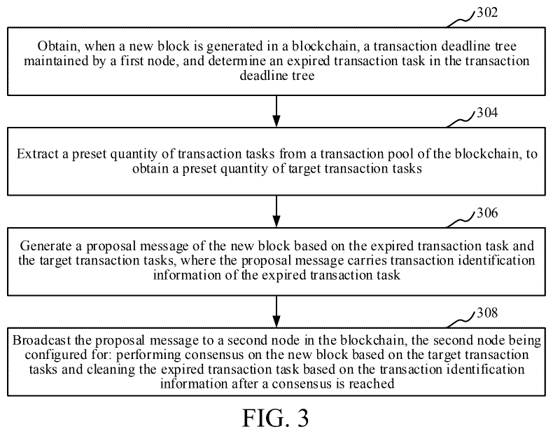

In an embodiment, as shown in FIG. 3, a data cleaning method for a blockchain is provided. The method being applied to a first node in the blockchain system in FIG. 1 is taken as an example for explanation. The first node may be any node in the blockchain system. The method specifically includes the following operations:

Operation 302: Obtain, when a new block is generated in the blockchain, a transaction deadline tree maintained by the first node, and determine an expired transaction task in the transaction deadline tree.

The blockchain is a chain composed of one block and another block. Each block saves particular information, and the blocks are connected into a chain according to a sequence of generation time. This chain is stored in all servers. The entire blockchain is secure as long as one server in an entire system can work. These servers are referred to as nodes in the blockchain system, and provide a storage space and computing power support for the entire blockchain system. To modify information in the blockchain, more than half of the nodes need to agree and modify information in all the nodes. These nodes are usually controlled by different bodies. Therefore, it is extremely difficult to tamper with information in the blockchain. Compared with a conventional network, the blockchain has two major core features: First, it is difficult to tamper with data. Second, it is decentralized. Based on the two features, information recorded by the blockchain is more real and reliable, which can help solve a problem that people are not trusted with each other. Blockchain types include a public chain, a joint chain, a private chain, and the like. The blockchain system in this application may be a consortium blockchain system.

After a newly created blockchain is initiated, when a new block is generated in the blockchain, a primary node in a node cluster is responsible for generating a proposal message for the new block, broadcasting the proposal message to cause each secondary node to verify the proposal message, and determining whether the new block in the proposal message reaches a consensus. When the new block reaches a consensus, each node in the node cluster may add the new block into a local ledger, namely, store the new block. A consensus environment of the blockchain in this application may be a BFT consensus-based blockchain underlying model. In the BFT consensus-based blockchain underlying model, there are usually a primary node and secondary nodes. The primary node is responsible for generating a proposal for a new block, and each secondary node performs verification to determine whether a block in the proposal may reach a consensus. Byzantine fault tolerance (BFT) is a consensus mechanism.

The new block is a block newly generated in the blockchain. For example, if a blockchain 1 includes a genesis block and a block 1, the new block may be the block 1 in the blockchain 1.

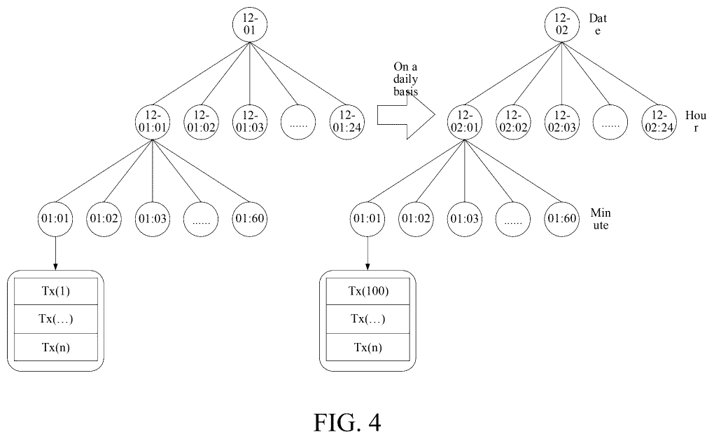

A transaction deadline tree is a structure for storing transaction identification information of an expired transaction task that needs to be cleaned. For example, the transaction deadline tree in this application may have a prefix tree structure, and the prefix tree is a multi-way tree structure. For example, FIG. 4 is a schematic structural diagram of a transaction deadline tree. To be specific, the transaction deadline tree in this application may be the structure shown in FIG. 4. The transaction deadline tree may include a root node, an intermediate node, and a leaf node. The root node is a node at a first level in the transaction deadline tree. The leaf node is a node at a last level in the transaction deadline tree. The intermediate node is a node between the first level and the last level in the transaction deadline tree. The root node may be on a daily basis, and each day may correspond to one transaction deadline tree. The intermediate node is further time-divided layer by layer. For example, the intermediate node may include a second-level node at an hourly granularity and a third-level node having a granularity of minute. The root node and the intermediate node may represent a target time. The target time represents a time limit when a transaction task expires. One target time corresponds to one leaf node, and the leaf node includes transaction identification information of a target transaction task that expires at the target time.

The expired transaction task is a transaction task satisfying preset expiration time. In some cases, a transaction task in this application may alternatively be referred to as a transaction, and the expired transaction task is referred to as an expired transaction. For example, a user may set an expiration time (either absolute time or relative time) for each transaction task. At the expiration time, the transaction task is an expired transaction task. For example, expiration time T set for a transaction task A is 13:30 on Jul. 16, 2023. At the time T, for example, when time of a current moment is 13:31 on Jul. 16, 2023, the transaction task A is an expired transaction task.

Specifically, after a newly created blockchain is initiated, when a new block is generated in the blockchain and needs to reach a consensus, a first node serving as a primary node in a node cluster may extract a preset quantity of transaction tasks from a transaction pool, package the extracted transaction tasks into a proposal message of the new block, and broadcast the proposal message to a secondary node in the blockchain, so that the secondary node performs consensus on the new block based on the transaction tasks in the proposal message.

The first node serving as the primary node in this application may package the preset quantity of transaction tasks extracted into a proposal, and broadcast the proposal to all secondary nodes in the blockchain by a message. When each secondary node receives the proposal message, the secondary node may verify all the transaction tasks in the proposal message, to obtain a verification result. When the verification result indicates that at least one of all the transaction tasks in the proposal message is invalid, the secondary node generates a vote message that disapproves of the new block reaching a consensus. Meanwhile, the secondary node may receive a vote message broadcast by another node. When the quantity of vote messages that approve of the new block reaching a consensus among vote messages satisfies a preset condition, the new block may reach a consensus. To be specific, the new block may be added into the blockchain, and the nodes may add the new block into a local ledger.

When the first node serving as the primary node builds a new block, the first node serving as the primary node may first determine an expired transaction task in a transaction deadline tree maintained by the first node. To be specific, each node in the node cluster in this application maintains a transaction deadline tree. The transaction deadline tree stores transaction identification information of a to-be-cleaned expired transaction task. For example, when the first node serving as the primary node builds a new block, the first node serving as the primary node may obtain time t1 of a current moment, and search, based on the time t1, the transaction deadline tree maintained by the first node for an expired transaction task satisfying the time t1. To be specific, the first node serving as the primary node may search the transaction deadline tree maintained by the first node for transaction identification information of a transaction task that needs to be cleaned at the time t1.

For example, in a BFT consensus-based blockchain underlying model, after a newly created blockchain is initiated, when a new block is generated in the newly created blockchain, each node in a node cluster may determine whether the node is the first node. For example, each node in the node cluster may determine, according to a parameter in a block maintained by the node, whether the node satisfies a block generation condition. When a node determines that the node satisfies the block generation condition, the node is the first node serving as the primary node. The block generation condition is a condition for triggering block generation. For example, in this application, the block generation condition may be set to be that a height value is greater than a preset threshold which may be 1. A node for block generation has a qualification to package transaction tasks into a proposal message of a block waiting for reaching a consensus.

Further, after a node (a first node, node 1) in the node cluster determines that the node is the primary node, the first node serving as the primary node generates a block, and starts a new round of consensus. To be specific, the first node serving as the primary node is responsible for generating a proposal for the new block. FIG. 4 is the schematic structural diagram of the transaction deadline tree. Assuming that the transaction deadline tree maintained by the first node (node 1) serving as the primary node is shown in FIG. 4, when the first node (node 1) serving as the primary node builds the new block, the first node (node 1) serving as the primary node may obtain time of a current moment: t1: Dec. 1, 2001:01, and search, based on the time t1, the transaction deadline tree that is maintained by the first node and that is shown in FIG. 4 for an expired transaction task satisfying the time t1. To be specific, the first node serving as the primary node may search the transaction deadline tree maintained by the first node for transaction identification information of a transaction task that needs to be cleaned at the time t1, at least including: Tx(1) and Tx(n).

Operation 304: Extract a preset quantity of transaction tasks from a transaction pool of the blockchain, to obtain a preset quantity of target transaction tasks.

The transaction pool is configured for receiving a transaction task transmitted by a node and a transaction task transmitted by a client. The transaction pool has a function of verifying validity of a transaction task. In addition to basically verifying whether a transaction task expires and whether a format of a signature of the transaction task is correct, whether a transaction task has a double-spending situation needs to be verified.

The preset quantity is a quantity of transaction tasks that need to be packaged in the new block. For example, the preset quantity may be 100.

A target transaction task is a transaction task selected by the first node serving as the primary node from the transaction pool. For example, the target transaction tasks in this application may be transaction tasks selected by the first node serving as the primary node from the transaction pool in descending order of processing priorities corresponding to contracts of the transaction tasks.

Operation 306: Generate a proposal message of the new block based on the expired transaction task and the target transaction tasks, the proposal message carrying transaction identification information of the expired transaction task.

The proposal message is a communication message during communication between the nodes in the blockchain. For example, the communication message may further include a consensus message, a vote message, and the like. The proposal message in this application is a message that carries a proposal. For example, a proposal message carries a proposal 1, and the proposal 1 is generated for a newly generated block 1.

Transaction identification information is transaction identification information corresponding to an expired transaction task. The transaction identification information corresponding to the expired transaction task in this application may include at least two types of transaction identification information. For example, the transaction identification information corresponding to the expired transaction task in this application may include an expired transaction identification set and an expired transaction hash value.

An expired transaction identification set is a set composed of transaction identifications of expired transaction tasks. For example, the expired transaction identification set in this application may be an expired transaction identification (ID) set, and the expired transaction identification set may alternatively be referred to as ExpireTxIDs, which includes a transaction task ID list that needs to be removed.

The expired transaction hash value is a MerkleRoot of the expired transaction identification set. The expired transaction hash value may alternatively be referred to as ExpireTxRoot.

Operation 308: Broadcast the proposal message to a second node in the blockchain, the second node being configured for: performing consensus on the new block based on the target transaction tasks and cleaning the expired transaction task based on the transaction identification information after a consensus is reached.

A second node is a node in the node cluster other than a current node (the first node serving as the primary node). For example, the second node in this application may be each secondary node in the node cluster.

Consensus means performing consensus on a newly generated new block. Only after the newly generated new block passes through the verification by a secondary node and reaches a consensus, can the new block be uploaded to a blockchain, and each node may store the new block reaching a consensus into a local ledger.

Data cleaning means an operation of cleaning expired data. For example, the data cleaning in this application cleans, by using a transaction task as a granularity, stored data related to the expired transaction task. For example, for an expired transaction task, state data of the expired transaction task is stored in a state database, and block data of the expired transaction task is stored in a block database. In an actual application scenario, only the block data of the expired transaction task stored in the block database may be selected to be cleaned. Or, block data of the expired transaction task stored in the block database and state data of the expired transaction task stored in the state database may be selected to be cleaned. The operation of data cleaning in this application includes, but is not limited to, deletion, compression, filing, backup, and the like.

Specifically, when a first node serving as a primary node in a node cluster builds a new block, after the first node serving as the primary node determines an expired transaction task in the transaction deadline tree maintained by the first node, the first node serving as the primary node may extract a preset quantity of transaction tasks from a transaction pool, to obtain a preset quantity of target transaction tasks, and generate a proposal message of the new block based on the expired transaction task and the target transaction tasks. The proposal message carries transaction identification information of the expired transaction task. To be specific, the first node serving as the primary node in this application may package the preset quantity of target transaction tasks extracted into a proposal. Meanwhile, the first node serving as the primary node may add transaction identification information of the expired transaction task into the proposal, and broadcast the proposal to all secondary nodes in the blockchain by a message.

Further, when each secondary node receives the proposal message, each secondary node may verify the transaction identification information of the target transaction tasks and the expired transaction task in the proposal message to obtain a verification result. The secondary node generates an affirmative vote message or a negative vote message based on the verification result. Meanwhile, the secondary node may receive a vote message broadcast by another node. When a quantity of affirmative votes in the vote message satisfies a preset condition, the new block may reach a consensus, namely, the new block may be added into the blockchain, and each node may further add the new block into a local ledger. After the new block reaches a consensus, each node may perform an operation of data cleaning based on the transaction identification information of the expired transaction task carried in the proposal message.

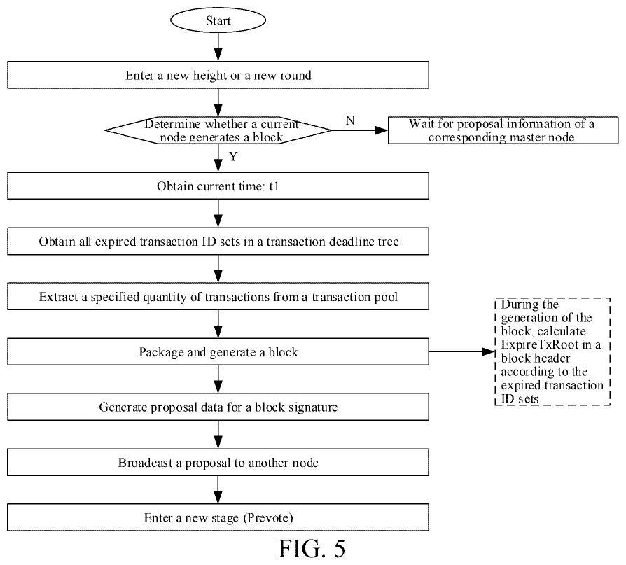

For example, in a BFT consensus-based blockchain underlying model, FIG. 5 is a schematic diagram showing a proposing process of a first node serving as a primary node. After a newly created blockchain is initiated, when a new block is generated in the newly created blockchain, each node in a node cluster may determine whether the node is the first node serving as the primary node. For example, each node in the node cluster may determine, according to a parameter in a block maintained by the node, whether the node satisfies a block generation condition. When a node determines that the node itself satisfies the block generation condition, the node is the primary node. The block generation condition is a condition for triggering block generation. For example, in this application, the block generation condition may be set to be that a height value is greater than a preset threshold which may be 1. A node for block generation has a qualification to package transaction tasks into a proposal message of a block waiting for reaching a consensus.

Further, after a node (a first node, node 1) in the node cluster determines that the node is the first node serving as the primary node, the first node serving as the primary node generates a block, and starts a new round of consensus. To be specific, the first node serving as the primary node is responsible for generating a proposal for the new block. To be specific, when the first node serving as the primary node builds the new block, the first node serving as the primary node may obtain time of a current moment: t1: Dec. 1, 2001:01. After searching, based on the time t1, the transaction deadline tree that is maintained by the first node, as shown in FIG. 4, for an expired transaction task satisfying the time t1, the first node serving as the primary node may extract a preset quantity of transaction tasks from a transaction pool, to obtain a preset quantity of target transaction tasks, and generate a proposal message of the new block based on the expired transaction task and the target transaction tasks. The proposal message carries transaction identification information of the expired transaction task. To be specific, the first node serving as the primary node in this application may package the preset quantity of target transaction tasks extracted into a proposal. Meanwhile, the first node serving as the primary node may add transaction identification information of the expired transaction task into the proposal. For example, when generating a block, the first node serving as the primary node may add an expired transaction hash value (ExpireTxRoot) into a block header of the new block, the expired transaction hash value (ExpireTxRoot) being a MerkleRoot calculated, according to an expired transaction ID, by the first node serving as the primary node, and broadcast the proposal to all secondary nodes in the blockchain by a message.

Further, when a secondary node receives the proposal message broadcast by the first node serving as the primary node, the secondary node may deserialize the proposal message to obtain processed proposal structure information, and obtain proposal time and the transaction identification information of the expired transaction task from the proposal structure information. The secondary node may determine whether the proposal time is valid. When determining that the proposal time is valid, the secondary node may obtain a local expired transaction task satisfying the proposal time from a transaction deadline tree maintained by the secondary node, and compare the transaction identification information of the local expired transaction task with the transaction identification information of the expired transaction task carried in the proposal message, to obtain a comparison result.

Further, when the comparison result indicates that the transaction identification information of the local expired transaction task is consistent with the transaction identification information of the expired transaction task carried in the proposal message, the secondary node may further verify the target transaction tasks in the proposal message. To be specific, the secondary node executes all the target transaction tasks included in the proposal message to obtain execution results, and determines whether the execution results obtained by the secondary node are consistent with execution results of the target transaction tasks carried in the proposal message.

When determining that the execution results obtained by the secondary node are consistent with the execution results of the target transaction tasks carried in the proposal message, the secondary node generates an affirmative vote and broadcasts the affirmative vote to another node by a message. When determining that the execution results obtained by the secondary node are inconsistent with the execution results of the target transaction tasks carried in the proposal message, the secondary node generates a negative vote and broadcasts the negative vote to another node by a message.

Meanwhile, the secondary node may receive a vote message broadcast by the another node. When a quantity of affirmative votes among vote messages satisfy a preset condition, the new block may reach a consensus. To be specific, the new block may be added into the blockchain, and each node may add the new block into a local ledger. After the new block reaches a consensus, each node may perform an operation of data cleaning based on the transaction identification information of the expired transaction task carried in the proposal message.

For example, the operation of data cleaning in this embodiment of this application may be an operation of data deletion based on the transaction identification information of the expired transaction task carried in the proposal message. The preset condition is a preset condition that a preset block reaches a consensus. For example, the preset condition may be set to be 2f+1, where f means a maximum allowable quantity of malicious nodes in a current environment. Byzantine consensus involves 3f+1 models. For example, if there are four nodes in an entire environment (the blockchain system), it is allowed that only f=1 node is a malicious node, and there are 2f+1 correct nodes. To be specific, when the quantity of the affirmative votes among the vote messages satisfies 2f+1, the block may reach a consensus.

In addition, when the quantity of the affirmative votes among the vote messages does not satisfy the preset condition (2f+1), the new block may not reach a consensus. To be specific, when the new block does not reach a consensus, each secondary node does not perform the operation of data cleaning. To be specific, a transaction task that is cleaned in this application is certainly a transaction task in a ledger. To be specific, a transaction task on which data cleaning is performed in this application is a transaction task that reaches a consensus. Therefore, cleaning on a transaction task that does not reach a consensus may be effectively avoided, and a case in which execution states are inconsistent can be effectively avoided.

In this embodiment, when a new block is built, an expired transaction task in a transaction deadline tree maintained by a node is determined. A preset quantity of transaction tasks are extracted from a transaction pool to obtain a preset quantity of target transaction tasks, and a proposal message of the new block is generated based on the expired transaction task and the target transaction tasks. The proposal message carries transaction identification information of the expired transaction task. The proposal message is broadcast to a second node in the blockchain to cause the second node to perform consensus on the new block based on the target transaction tasks and clean the expired transaction task based on the transaction identification information after a consensus is reached. Since the proposal message of the new block is generated based on the expired transaction task and the target transaction tasks, after the new block reaches a consensus, the expired transaction task may be automatically cleaned based on the transaction identification information of the expired transaction task carried in the proposal message. In the entire data cleaning process, a consensus is reached, and the process may be written into the blockchain, so that the data cleaning process may be completed while reaching a consensus, with high security and traceability. In addition, a level of data cleaning in the blockchain may alternatively be controlled to a transaction level. In this way, no error will occur even if services share the same chain. Therefore, performance of the entire blockchain can be effectively improved while the security of the entire blockchain is ensured.

In an embodiment, the determining an expired transaction task in the transaction deadline tree includes: obtaining time of building the new block, to obtain first time; and determining the expired transaction task in the transaction deadline tree based on the first time.

The first time is time of generating the new block, or may be referred to as proposal time. For example, when the first node serving as the primary node builds the new block, the first node serving as the primary node may obtain that a time stamp t1 of a current moment, and t1 is the first time.

Specifically, in a BFT consensus-based blockchain underlying model, after a node (node 1) in the node cluster determines that the node is the first node serving as the primary node, the first node serving as the primary node generates a block, and starts a new round of consensus. To be specific, the first node serving as the primary node is responsible for generating a proposal for the new block. Assuming that the transaction deadline tree maintained by the first node (node 1) serving as the primary node is shown in FIG. 4, when the first node (node 1) serving as the primary node builds the new block, the first node (node 1) serving as the primary node may obtain a time stamp of a current moment: t1: Dec. 1, 2001:01, and search, based on t1, the transaction deadline tree that is maintained by the first node, as shown in FIG. 4, for an expired transaction task satisfying the time t1. To be specific, the first node serving as the primary node may search the transaction deadline tree maintained by the first node for transaction identification information of a transaction task that needs to be cleaned at the time t1, at least including: Tx(1) and Tx(n). Therefore, a to-be-cleaned expired transaction task may be determined according to the proposal time, and a level of blockchain data cleaning may be controlled to a transaction level. In this way, no error will occur even if services share the same chain, thereby effectively improving accuracy of data cleaning.

In an embodiment, the preset quantity is at least two, and the data cleaning method for the blockchain further includes: obtaining, after the new block reaches a consensus, blockchain identifications, transaction identification information, and transaction expiration time that are carried in the at least two target transaction tasks; generating a transaction deadline tree based on the blockchain identifications, the transaction identification information, and the transaction expiration time, a leaf node of the transaction deadline tree including the transaction identification information of the target transaction tasks; and storing the transaction identification information of the at least two target transaction tasks into the same leaf node when the transaction expiration time of the at least two target transaction tasks is the same.

In an embodiment, when the blockchain is initiated, a computer device may create a transaction deadline tree; create, after the new block reaches a consensus, a root node, an intermediate node, and a leaf node in the transaction deadline tree based on blockchain identifications, transaction identification information, and transaction expiration time that are carried in at least two target transaction tasks, where the leaf node includes transaction identification information of a target transaction task that needs to be cleaned; and store the transaction identification information of the at least two target transaction tasks into the same leaf node when the transaction expiration time of the at least two target transaction tasks is the same.

A blockchain identification is configured for distinguishing a plurality of chains, and may alternatively be referred to as a chain identification (ChainID). For example, a chain identification of a blockchain 1 is Chain1.

The transaction identification information is a transaction identification of a target transaction task, and may alternatively be referred to as a transaction ID (TxID). For example, a transaction identification of a target transaction task is Tx1.

The transaction expiration time is expiration time that is set in advance, and may be relative time or absolute time. If the transaction expiration time is the relative time, time of creating the transaction task is used as counting start time. For example, the transaction expiration time of a target transaction task is: Dec. 1, 2001:01 (absolute time).

The root node is a first-level node in the transaction deadline tree. The root node in the transaction deadline tree in this application may be created according to a time period. For example, a root node on a daily basis is created in the transaction deadline tree.

The intermediate node is a node for representing time information. The intermediate node in this application may include a second-level node and a third-level node. For example, after the root node on a daily basis is created in the transaction deadline tree, a second-level node at an hourly granularity and a third-level node at a minute granularity are created in the transaction deadline tree.

The leaf node is configured for storing transaction identification information of a transaction task that needs to be cleaned. For example, the third-level node in this application is a minimum-level node. Each third-level node corresponds to one leaf node. The leaf node includes transaction identification information of transaction tasks that need to be cleaned at target time represented by the third-level node.

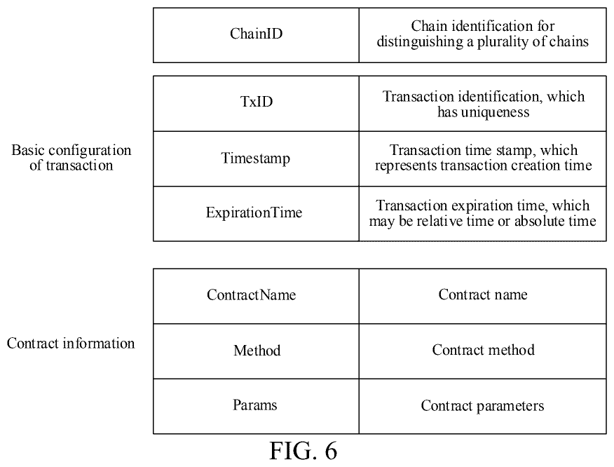

Specifically, FIG. 6 is a schematic diagram showing information carried in a transaction task. In a basic configuration of a transaction task shown in FIG. 6, to enable the transaction task to be processed when the transaction task expires, expiration time needs to be defined in the basic configuration of the transaction task. The expiration time may be relative or absolute. If the expiration time is the relative time, time of creating the transaction task is used as counting start time. The basic configuration of the transaction task shown in FIG. 6 at least includes at least: a chain identification (ChainID), a transaction ID (TxID), a transaction time stamp (Timestamp), a transaction expiration time (ExpirationTime), and contract information.

When a blockchain is initiated, a transaction deadline tree is created. To be specific, after the blockchain is initiated, each node in a node cluster may locally create the transaction deadline tree shown in FIG. 4. After a new block in the blockchain reaches a consensus, each node may create, based on blockchain identifications, transaction identification information, and transaction expiration time that are carried in at least two target transaction tasks included in the new block, a root node, an intermediate node, and a leaf node in the transaction deadline tree maintained by the node. To be specific, the node may store transaction identification information of transaction tasks in the transaction deadline tree based on transaction expiration time of transaction tasks according to a chronological order of the transaction expiration time. When the transaction expiration time of the at least two transaction tasks is the same, the node may store the transaction identification information of the at least two transaction tasks into the same leaf node. To be specific, the leaf node of the transaction deadline tree shown in FIG. 4 includes a transaction ID list that needs to be cleaned at target time corresponding to the leaf node.

In this application, the transaction deadline tree maintained by each node dynamically changes. To be specific, after a new block in the blockchain reaches a consensus, each node may create, based on a blockchain identification, transaction identification information, and transaction expiration time that are carried in a target transaction task included in the new block, a corresponding branch node in the transaction deadline tree maintained by each node. When there is no to-be-cleaned data at a particular time, no corresponding branch node needs to be created, so as to save a memory. Therefore, a to-be-cleaned expired transaction task may be determined according to the proposal time, and transaction identification information of the to-be-cleaned expired transaction task is stored by using a prefix tree structure, so that a level of blockchain data cleaning may be controlled to a transaction level. In this way, no error will occur even if services share the same chain, thereby effectively improving accuracy of data cleaning. In addition, the prefix tree structure and the time stamp are combined to define a transaction deadline tree structure that needs to be dynamically maintained by each node, so that the entire cleaning process does not require manual participation, but is automatically triggered and executed, thereby effectively improving processing efficiency of the entire blockchain.

In an embodiment, the transaction deadline tree includes a root node and an intermediate node. The intermediate node includes a second-level node and a third-level node. The generating a transaction deadline tree based on the blockchain identifications, the transaction identification information, and the transaction expiration time includes: creating, based on the blockchain identifications, the transaction identification information, and the transaction expiration time, the root node that is on a daily basis, the second-level node at an hourly granularity, the third-level node at a minute granularity, and a leaf node corresponding to target time represented by the third-level node, the leaf node including the transaction identification information of a target transaction task that expires at the target time.

The root node is a first-level node in the transaction deadline tree. The root node in the transaction deadline tree in this application may be created according to a time period. For example, a root node on a daily basis is created in the transaction deadline tree.

The intermediate node is a node for representing time information. The intermediate node in this application may include a second-level node and a third-level node. For example, after the root node on the daily basis is created in the transaction deadline tree, a second-level node at an hourly granularity, and a third-level node at a minute granularity are created in the transaction deadline tree.

The leaf node is configured for storing transaction identification information of a transaction task that needs to be cleaned. For example, the third-level node in this application is a minimum-level node. Each third-level node corresponds to one leaf node. The leaf node includes transaction identification information of transaction tasks that need to be cleaned at target time represented by the third-level node.

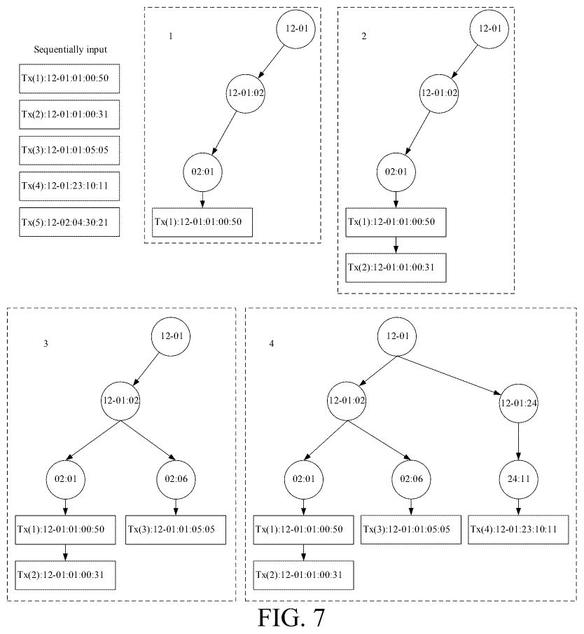

Specifically, FIG. 7 is a schematic diagram showing a process of creating a transaction deadline tree. After a new block 1 reaches a consensus, it is assumed that target transaction tasks included in the new block 1 are transaction tasks shown on the left hand side of FIG. 7: Tx(1): 12-01:01:00:50, Tx(2): 12-01:01:00:31, Tx(3): 12-01:01:05:05, Tx(4): 12-01:23:10:11, and Tx(5): 12-02:04:30:21. After the new block 1 reaches a consensus, each node may construct a branch node of each transaction task in the transaction deadline tree shown in FIG. 7 according to an expiration time sequence of the transaction tasks included in the new block 1. To be specific, each node in a node cluster may create, in the transaction deadline tree based on transaction expiration time carried in a first transaction task Tx(1): 12-01:01:00:50, a root node on a daily basis, a second-level node at an hourly granularity, a third-level node at a minute granularity, and a leaf node corresponding to target time (01:00:50) represented by the third-level node, and store transaction identification information of the first transaction task Tx(1): 12-01:01:00:50 into the leaf node, to obtain a branch node shown by 1 in FIG. 7. Similarly, each node may create, in the transaction deadline tree based on transaction expiration time carried in Tx(2): 12-01:01:00:31, Tx(3): 12-01:01:05:05, Tx(4): 12-01:23:10:11, and Tx(5): 12-02:04:30:21, root nodes on a daily basis, second-level nodes at an hourly granularity, third-level nodes at a minute granularity, and leaf nodes corresponding to target time (01:00:31, 01:05:05, 23:10:11, or 04:30:21) represented by the third-level nodes, and store transaction identification information of the transaction tasks into the corresponding leaf nodes, to obtain branch nodes shown by 2, 3, and 4 in FIG. 7. In the structure of the transaction deadline tree shown in FIG. 7, the root node represents day; the second-level node represents hour; the third-level node represents minute; and the last leaf node includes a transaction ID list that needs to be cleaned at target time corresponding to the leaf node.

As shown in FIG. 4, to improve processing performance, it is generally recommended to maintain a relationship of a transaction deadline tree of a next day when a current day is about to end, namely, when a time length to the current end reaches a preset time length, for example, one hour.

In addition, expiration time of a transaction task sent by a user is not allowed to be historical time, and it is better to reserve a time error range.

In this embodiment, a to-be-cleaned expired transaction task may be determined according to the proposal time, and transaction identification information of the to-be-cleaned expired transaction task is stored by using a prefix tree structure, so that a level of blockchain data cleaning may be controlled to a transaction level. In this way, no error will occur even if services share the same chain, thereby effectively improving accuracy of data cleaning. In addition, the prefix tree structure and the time stamp are combined to define a transaction deadline tree structure that needs to be dynamically maintained by each node, so that the entire cleaning process does not require manual participation, but is automatically triggered and executed, thereby effectively improving processing efficiency of the entire blockchain.

In an embodiment, the transaction identification information includes an expired transaction hash value, and the generating a proposal message of the new block based on the expired transaction task and the target transaction tasks includes: determining an expired transaction identification set based on the expired transaction task; determining the expired transaction hash value according to the expired transaction identification set; adding the expired transaction hash value into a block header of the new block; and generating the proposal message of the new block according to the block header and the target transaction tasks.

In an embodiment, the transaction identification information includes an expired transaction identification set, and the generating a proposal message of the new block based on the expired transaction task and the target transaction tasks includes: determining the expired transaction identification set based on the expired transaction task; adding the expired transaction identification set into a block header of the new block; and generating the proposal message of the new block according to the block header and the target transaction tasks.

Specifically, when a first node serving as a primary node in a node cluster builds a new block, after the first node serving as the primary node determines an expired transaction task in the transaction deadline tree maintained by the first node, the first node serving as the primary node may extract a preset quantity of transaction tasks from a transaction pool, to obtain a preset quantity of target transaction tasks, and package the preset quantity of target transaction tasks extracted into a proposal. Meanwhile, the first node serving as the primary node may add transaction identification information of the expired transaction task into the proposal, and broadcast the proposal to all secondary nodes in the blockchain by a message.

The transaction identification information may be at least one of the expired transaction identification set or the expired transaction hash value. The expired transaction hash value is a hash value obtained by performing a hash operation on the expired transaction identification set.

The first node serving as the primary node may determine an expired transaction task from the transaction deadline tree maintained by the first node, add a transaction identification of each expired transaction task into the expired transaction identification set, and calculate the expired transaction hash value based on the expired transaction identification set.

Further, the first node serving as the primary node may add the expired transaction hash value into a block header of the new block, to generate a proposal message of the new block based on the block header and the target transaction tasks, so that transaction identification information of the expired transaction task carried in the proposal message of the new block is the expired transaction hash value.

Or, the first node serving as the primary node may directly add the expired transaction identification set into a block header of the new block, to generate a proposal message of the new block based on the block header and the target transaction tasks, so that transaction identification information of the expired transaction task carried in the proposal message of the new block is the expired transaction identification set.

For example, in a BFT consensus-based blockchain underlying model, when a first node serving as a primary node in a node cluster builds a new block, after the first node serving as the primary node determines an expired transaction task in the transaction deadline tree maintained by the first node, the first node serving as the primary node may extract a preset quantity of transaction tasks from a transaction pool, to obtain a preset quantity of target transaction tasks, and package the preset quantity of target transaction tasks extracted into a proposal. Meanwhile, the first node serving as the primary node may add transaction identification information of the expired transaction task into the proposal, and broadcast the proposal to all secondary nodes in the blockchain by a message.

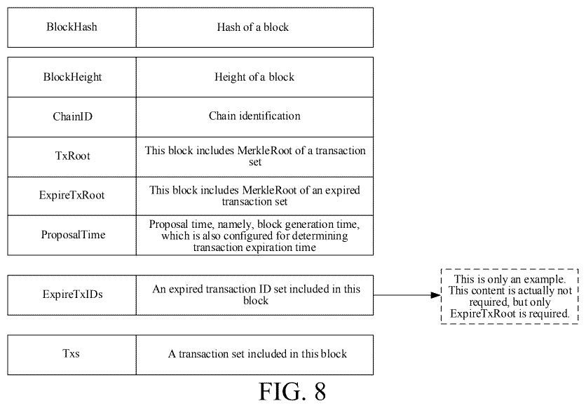

FIG. 8 is a schematic diagram showing information carried in a proposal message. As shown in FIG. 8, transaction identification information of an expired transaction task may include: an expired transaction identification set (ExpireTxIDs) and an expired transaction hash value (ExpireTxRoot). Some proposal messages may carry the expired transaction identification set (ExpireTxIDs), and some proposal messages may not carry the expired transaction identification set (ExpireTxIDs). Therefore, when a first node serving as a primary node in a node cluster builds a new block, the first node serving as the primary node may store an expired transaction task ID obtained from a transaction deadline tree maintained by the first node serving as the primary node into the expired transaction identification set, calculate a MerkleRoot of the expired transaction identification set, and use the calculated MerkleRoot of the expired transaction identification set as the expired transaction hash value (ExpireTxRoot). Further, the first node serving as the primary node may add the expired transaction hash value (ExpireTxRoot) into a block header of the new block, so that transaction identification information of the expired transaction task carried in the proposal message of the new block is the expired transaction hash value (ExpireTxRoot). Or,

the first node serving as the primary node may directly add the expired transaction identification set (ExpireTxIDs) into a block header of the new block, so that transaction identification information of the expired transaction task carried in the proposal message of the new block is the expired transaction identification set (ExpireTxIDs). To be specific, the first node serving as the primary node in this application needs to add a cleaned (filed) transaction ID into the proposal during proposing. The proposal is generally a block plus node signature. To be specific, the first node serving as the primary node in this application needs to add a to-be-cleaned transaction ID set into the new block during building of the new block. The expired transaction hash value (ExpireTxRoot) and the proposal time (ProposalTime) are two necessary fields. The former is a MerkleRoot calculated for a transaction ID set that needs to be cleaned. The latter is mainly configured for determining a processing time range. Therefore, by combining a transaction deadline tree with a time stamp, a level of blockchain data cleaning may be controlled to a transaction level. In this way, no error will occur even if services share the same chain, thereby effectively improving accuracy of data cleaning. In addition, the entire cleaning process does not require manual participation, but is automatically triggered and executed, thereby effectively improving processing efficiency of the entire blockchain.

In an embodiment, the transaction identification information includes an expired transaction identification set and an expired transaction hash value, and the generating a proposal message of the new block based on the expired transaction task and the target transaction tasks includes: determining the expired transaction identification set based on the expired transaction task; determining the expired transaction hash value according to the expired transaction identification set; adding the expired transaction identification set and the expired transaction hash value into a block header of the new block; and generating the proposal message of the new block according to the block header and the target transaction tasks.

Or, the first node serving as the primary node may add both the expired transaction identification set and the expired transaction hash value into a block header of the new block, to generate a proposal message of the new block based on the block header and the target transaction tasks, so that transaction identification information of the expired transaction task carried in the proposal message of the new block is that the transaction identification information includes the expired transaction identification set and the expired transaction hash value.

Specifically, FIG. 8 is a schematic diagram showing information carried in a proposal message. As shown in FIG. 8, transaction identification information of an expired transaction task may include: an expired transaction identification set (ExpireTxIDs) and an expired transaction hash value (ExpireTxRoot). Some proposal messages may carry the expired transaction identification set (ExpireTxIDs) and the expired transaction hash value (ExpireTxRoot). Therefore, when a first node serving as a primary node in a node cluster builds a new block, the first node serving as the primary node may store an expired transaction task ID obtained from a transaction deadline tree maintained by the first node serving as the primary node into the expired transaction identification set (ExpireTxIDs), calculate a MerkleRoot of the expired transaction identification set, and use the calculated MerkleRoot of the expired transaction identification set as the expired transaction hash value (ExpireTxRoot). Further, the first node serving as the primary node may add both the expired transaction hash value (ExpireTxRoot) and the expired transaction identification set (ExpireTxIDs) into a block header of the new block, so that transaction identification information of the expired transaction task carried in the proposal message of the new block includes the expired transaction hash value (ExpireTxRoot) and the expired transaction identification set (ExpireTxIDs).

The proposal message in this application may carry ExpireTxIDs which includes a transaction ID list that needs to be deleted after the current consensus is reached. Or, the proposal message may not carry ExpireTxIDs. Usually, a transaction per second (TPS) of a blockchain system that does not carry ExpireTxIDs is at a minute level, namely, each proposal has a minute interval. In this way, the proposal can adapt to the transaction deadline tree maintained by each node in this application. If a TPS of a blockchain system is at a high level, the proposal message needs to carry ExpireTxIDs, so that a transaction ID set that needs to be cleaned this time can be clearly confirmed.

In this embodiment, by combining a transaction deadline tree with a time stamp, a to-be-cleaned expired transaction task may be determined according to the proposal time, and a level of blockchain data cleaning may be controlled to a transaction level. In this way, no error will occur even if services share the same chain, thereby effectively improving accuracy of data cleaning. In addition, the entire cleaning process does not require manual participation, but is automatically triggered and executed, thereby effectively improving processing efficiency of the entire blockchain.

In an embodiment, the proposal message carries the first time and the expired transaction hash value; the first time is time of building the new block; and the second node is further configured for: deserializing the proposal message to obtain processed proposal structure information; obtaining the first time from the proposal structure information; obtaining, when the first time is valid and the expired transaction identification set is not obtained, a local expired transaction task that satisfies the first time from a transaction deadline tree maintained by the second node; determining a hash value corresponding to the local expired transaction task; comparing the hash value with the expired transaction hash value to obtain a comparison result; generating negative vote information when the comparison result indicates that the hash value is inconsistent with the expired transaction hash value; and broadcasting the negative vote information to another node, the another node being a node in the blockchain system other than the second node.

The operation of performing consensus on the new block based on the target transaction tasks includes: deserializing the proposal message to obtain processed proposal structure information; obtaining the first time from the proposal structure information; obtaining, when the first time is valid and the expired transaction identification set is not obtained, a local expired transaction task that satisfies the first time from a transaction deadline tree maintained by the second node; determining a hash value corresponding to the local expired transaction task; comparing the hash value with the expired transaction hash value to obtain a comparison result; generating negative vote information when the comparison result indicates that the hash value is inconsistent with the expired transaction hash value; and broadcasting the negative vote information to another node, the another node being a node in the blockchain system other than the second node.

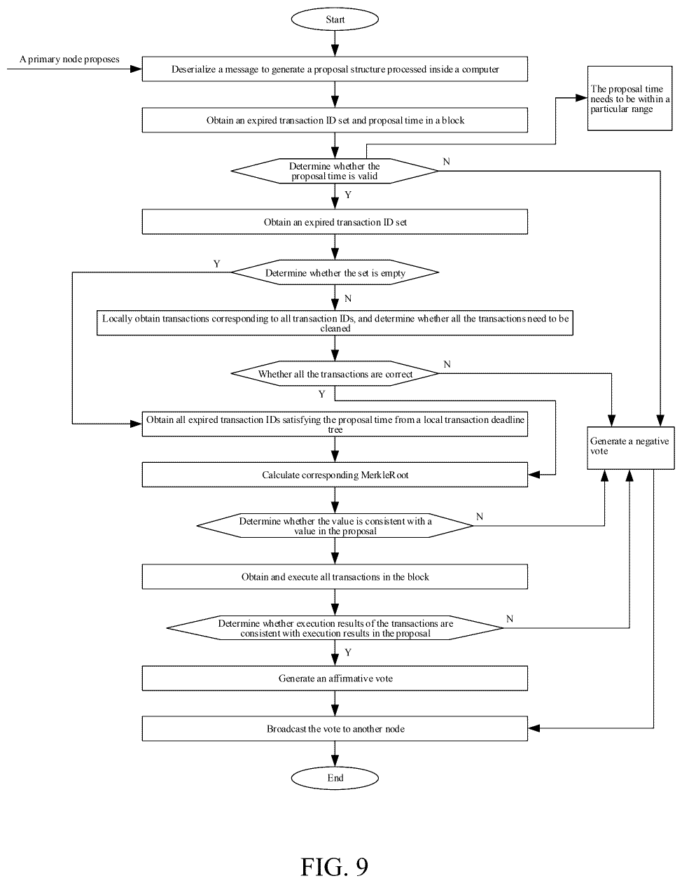

Specifically, FIG. 9 is a schematic diagram showing a verification process after receiving a proposal message from a node. After a first node serving as a primary node broadcasts the proposal message that carries first time (proposal time) and an expired transaction hash value to each secondary node in a blockchain, when the secondary node receives the proposal message, a procedure in which the secondary node verifies the proposal message is shown in FIG. 9. To be specific, the secondary node may deserialize the proposal message to obtain processed proposal structure information, and obtain the first time and the expired transaction identification set from the proposal structure information. To be specific, a proposal structure includes a field for representing the proposal time and a field for representing the expired transaction identification set. Further, the secondary node may determine whether the first time (i.e. the proposal time) is valid. If the first time is valid, the secondary node further determines whether the expired transaction identification set is an empty set. If the expired transaction identification set is an empty set, the secondary node may obtain a local expired transaction task satisfying the first time from a transaction deadline tree maintained by the secondary node, and calculate a hash value corresponding to the local expired transaction task. Further, the secondary node may compare the hash value calculated by the secondary node with an expired transaction hash value carried in the proposal message, to obtain a comparison result. When the comparison result indicates that the hash value calculated by the secondary node is inconsistent with the expired transaction hash value carried in the proposal message, the secondary node may generate a negative vote message and broadcast the negative vote message to another node. Therefore, in the entire data cleaning process, a consensus is reached, and the process may be written into the blockchain, which has high security and traceability.

In an embodiment, the second node is further configured for: obtaining the target transaction tasks from the proposal structure information in a case that the comparison result indicates that the hash value is consistent with the expired transaction hash value, and executing the target transaction tasks to obtain execution results corresponding to the target transaction tasks; and generating an affirmative vote message when the execution results are consistent with execution results carried in the proposal message, and broadcasting the affirmative vote message to the another node.

After comparing the hash value with the expired transaction hash value to obtain the comparison result, the second node may obtain, when the comparison result indicates that the hash value and the expired transaction hash value are consistent, the target transaction tasks from the proposal structure information and executes the target transaction tasks to obtain the execution results corresponding to the target transaction tasks; and when the execution results are consistent with the execution results carried in the proposal message, generate the affirmative vote message and broadcast the affirmative vote message to the another node.

Specifically, FIG. 9 is a schematic diagram showing a verification process after receiving a proposal message from a node. After a first node serving as a primary node broadcasts the proposal message that carries first time (proposal time) and an expired transaction hash value to each secondary node in a blockchain, when the secondary node receives the proposal message, a procedure in which the secondary node verifies the proposal message is shown in FIG. 9. To be specific, the secondary node may deserialize the proposal message to obtain processed proposal structure information, and obtain the first time and the expired transaction identification set from the proposal structure information. To be specific, a proposal structure includes a field for representing the proposal time and a field for representing the expired transaction identification set. Further, the secondary node may determine whether the first time (i.e. the proposal time) is valid. If the first time is valid, the secondary node further determines whether the expired transaction identification set is an empty set. If the expired transaction identification set is an empty set, the secondary node may obtain a local expired transaction task satisfying the first time from a transaction deadline tree maintained by the secondary node, and calculate a hash value corresponding to the local expired transaction task. Further, the secondary node may compare the hash value calculated by the secondary node with an expired transaction hash value carried in the proposal message, to obtain a comparison result. When the comparison result indicates that the hash value calculated by the secondary node is consistent with the expired transaction hash value carried in the proposal message, the secondary node may continue to verify the target transaction tasks in the proposal message. To be specific, the secondary node may obtain all the target transaction tasks included in the proposal from the proposal structure information, and execute the target transaction tasks to obtain execution results corresponding to the target transaction tasks; and when the execution results of the target transaction tasks obtained by the secondary node are consistent with execution results of the target transaction tasks carried in the proposal message, generate an affirmative vote message and broadcast the affirmative vote message to the another node. Therefore, in the entire data cleaning process, a consensus is reached, and the process may be written into the blockchain, which has high security and traceability.

In an embodiment, the second node is further configured for: obtaining, in a case that the first time is valid and the expired transaction identification set is obtained, a local expired transaction task that satisfies the first time from the transaction deadline tree maintained by the second node; verifying the expired transaction identification set based on the local expired transaction task; and executing, when the verification succeeds, the operation of determining a hash value corresponding to the local expired transaction task.

After obtaining the first time from the proposal structure information, when the first time is valid and the expired transaction identification set is obtained, the second node may obtain the local expired transaction task satisfying the first time from the transaction deadline tree maintained by the second node; verify the expired transaction identification set based on the local expired transaction task; and execute, when the verification succeeds, the operation of determining a hash value corresponding to the local expired transaction task.

Specifically, FIG. 9 is a schematic diagram showing a verification process after receiving a proposal message from a node. After a first node serving as a primary node broadcasts the proposal message that carries first time and an expired transaction hash value to each secondary node in a blockchain, when the secondary node receives the proposal message, a procedure in which the secondary node verifies the proposal message is shown in FIG. 9. To be specific, the secondary node may deserialize the proposal message to obtain processed proposal structure information, and obtain the first time and the expired transaction identification set from the proposal structure information. Further, the secondary node may determine whether the first time (i.e. the proposal time) is valid. If the first time is valid, the secondary node further determines whether the expired transaction identification set is an empty set. If the expired transaction identification set is not an empty set, the secondary node may obtain a local expired transaction task satisfying the first time from a transaction deadline tree maintained by the secondary node, and verify the expired transaction identification set based on the local expired transaction task. To be specific, the secondary node may compare transaction IDs of expired transaction tasks in the expired transaction identification set according to a transaction ID of the local expired transaction task. When a comparison result indicates consistency, the verification succeeds, the secondary node may continue to execute the operation of determining a hash value corresponding to the local expired transaction task. Therefore, in the entire data cleaning process, a consensus is reached, and the process may be written into the blockchain, which has high security and traceability.

In an embodiment, the second node is further configured for: generating a negative vote message in a case that the first time is not within a time threshold range, and broadcasting the negative vote message to the another node.

After obtaining the first time from the proposal structure information, when the first time is not within the time threshold range, the second node generates the negative vote message, and broadcasts the negative vote message to the another node.

Specifically, FIG. 9 is a schematic diagram showing a verification process after receiving a proposal message from a node. After a first node serving as a primary node broadcasts the proposal message that carries first time and an expired transaction hash value to each secondary node in a blockchain, when the secondary node receives the proposal message, a procedure in which the secondary node verifies the proposal message is shown in FIG. 9. To be specific, the secondary node may deserialize the proposal message to obtain processed proposal structure information, and obtain the first time and the expired transaction identification set from the proposal structure information. Further, the secondary node may determine whether the first time (i.e. the proposal time) is valid. To be specific, the secondary node may determine whether the first time (i.e. the proposal time) is within a preset time threshold range. If the first time (i.e. the proposal time) is within the preset time threshold range, it indicates that the first time is valid. If the first time (i.e. the proposal time) is not within the preset time threshold range, namely, if the first time (i.e. the proposal time) does not satisfy the preset time threshold range, it indicates that the first time is invalid. To be specific, when the first time is invalid, the secondary node may generate a negative vote message and broadcast the negative vote message to the another node. Therefore, in the entire data cleaning process, a consensus is reached, and the process may be written into the blockchain, which has high security and traceability.

In an embodiment, the second node is further configured for: determining a first PreCommit message based on a first Prevote message of the second node and a second Prevote message when the second Prevote message broadcast by another node has been received; determining, based on the first PreCommit message and the second PreCommit message when the second PreCommit message broadcast by the another node has been received, that the new block reaches a consensus, and writing the target transaction tasks and the execution results of the target transaction tasks into a local ledger; obtaining a corresponding transaction task according to the expired transaction identification set when the block header of the new block carries the expired transaction identification set; obtaining an execution result corresponding to the obtained transaction task from a block database, and obtaining state data corresponding to the obtained transaction task at a current moment from a state database; and when the execution result is consistent with the state data, deleting the state data corresponding to the transaction task from the state database and deleting task data corresponding to the transaction task from the block database.

The performing consensus on the new block based on the target transaction tasks and cleaning the expired transaction task based on the transaction identification information after a consensus is reached includes: determining, by the second node, the first PreCommit message based on the first Prevote message of the second node and the second Prevote message when the second node receives the second Prevote message broadcast by the another node; when the second node receives the second PreCommit message broadcast by the another node, determining, by the second node based on the first PreCommit message and the second PreCommit message, that the new block reaches a consensus, and writing the target transaction tasks and the execution results of the target transaction tasks into the local ledger; obtaining a corresponding transaction task according to the expired transaction identification set when the block header of the new block carries the expired transaction identification set; when the transaction task is in a state data deletion mode, obtaining an execution result corresponding to the transaction task from the block database, and obtaining state data corresponding to the transaction task at a current moment from the state database; comparing the execution result with the state data to obtain a comparison result; and when the comparison result indicates that the execution result is consistent with the state data, deleting the state data corresponding to the transaction task from the state database and deleting the task data corresponding to the transaction task from the block database.

The first Prevote message and the first PreCommit message are configured only for distinguishing vote messages of different rounds of a current node. For example, the first Prevote message is a vote message of the current node in a first round, and the first PreCommit message is a vote message of the current node in a second round.

The second Prevote message and the second PreCommit message are configured only for distinguishing vote messages of different rounds of another node. For example, the second Prevote message is a vote message of the another node in a first round, and the second PreCommit message is a vote message of the another node in a second round.

The first Prevote message, the second Prevote message, the first PreCommit message, and the second PreCommit message in this application are only configured for distinguishing vote messages broadcast by different nodes in different rounds.

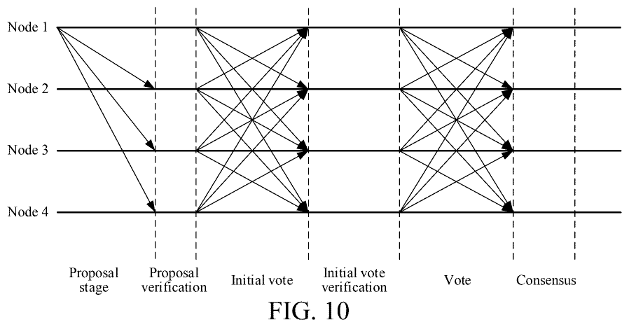

Specifically, FIG. 10 is a consensus flowchart of a BFT consensus algorithm. In a BFT consensus-based blockchain underlying model shown in FIG. 10, after a node (Node1) in a node cluster determines that the node is a first node (Leader) serving as a primary node, the first node serving as the primary node generates a block and initiates a new round of consensus. The first node serving as the primary node may broadcast a proposal message to secondary nodes (Node2, Node3, and Node4) in a blockchain, so that the secondary nodes (Node2, Node3, and Node4) perform consensus on the new block based on transaction tasks in the proposal message. As shown in FIG. 10, when a secondary node (Node4) in the node cluster receives the proposal message broadcast by the first node serving as the primary node, the secondary node (Node4) may perform the verification process shown in FIG. 9 and generate a first Prevote message. When the secondary node receives a second Prevote message broadcast by another node, the secondary node may generate a first PreCommit message based on the first Prevote message of the secondary node and the second Prevote message. When the secondary node receives a second PreCommit message broadcast by the another node, the secondary node may determine, based on the first PreCommit message and the second PreCommit message, whether a block corresponding to a block identification in the proposal message may reach a consensus. For example, when the quantity of vote messages that approve of the block reaching a consensus among the first PreCommit message and the second PreCommit message satisfies a preset condition (a quantity 2f+1), the secondary node may determine that the new block reaches a consensus and submits the new block to a ledger. Or, when the quantity of vote messages that approve of the block reaching a consensus among the first PreCommit message and the second PreCommit message does not satisfy the preset condition (the quantity 2f+1), the secondary node may determine that the new block does not reach a consensus and may enter a next round of consensus processing procedure.

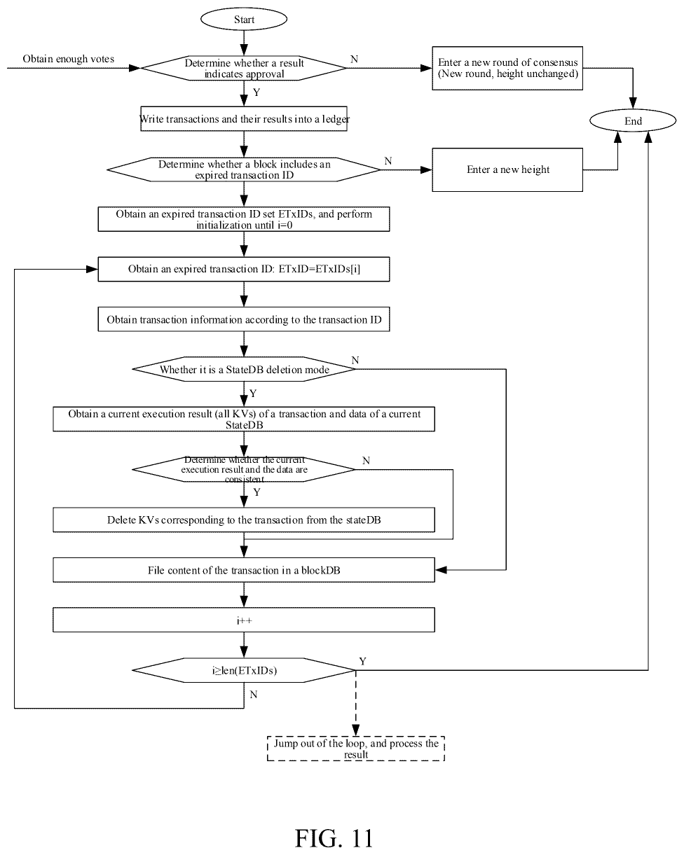

Further, FIG. 11 is a flowchart of cleaning of expired data. Where i shown in FIG. 11 represents an i^{th} transaction, and i++ represents that after i participates in an operation, a value of i is incremented by 1, and len(ETxIDs) in FIG. 11 represents a quantity of transaction IDs in an expired transaction ID set ETxIDs. When the secondary node determines that the new block reaches a consensus and submits the new block into the ledger, when an expired transaction ID exists in the expired transaction identification set (ExpireTxIDs) carried in a block header of the new block, the secondary node needs to clean expired data. A processing procedure is shown in FIG. 11. In the processing procedure shown in FIG. 11, when the block header of the new block carries the expired transaction identification set and the expired transaction ID exists in the expired transaction identification set (ExpireTxIDs), the secondary node may obtain corresponding transaction information according to the expired transaction ID in the expired transaction identification set and determine whether the transaction information is in a state data deletion mode (stateDB deletion mode). When the transaction information is in the state data deletion mode, the secondary node may obtain the execution result (key-value pair information) corresponding to the transaction task from the block database (blockDB), obtain the state data (key-value pair information) corresponding to the transaction task at the current moment from the state database (stateDB), and compare the execution result (key-value pair information) with the state data (key-value pair information) to obtain the comparison result. When the comparison result indicates that the execution result (key-value pair information) is consistent with the state data (key-value pair information), the secondary node may delete the state data (key-value pair information) corresponding to the transaction task from the state database and delete transaction content corresponding to the transaction task from the block database. Therefore, in the entire data cleaning process, a consensus is reached, and the process may be written into the blockchain, so that the data cleaning process may be completed while reaching a consensus, with high security and traceability. In addition, a level of data cleaning in the blockchain may alternatively be controlled to a transaction level. In this way, no error will occur even if services share the same chain. In addition, the state data in the state database may be cleaned to an extent. More data can be cleaned than data cleaned in a conventional manner. Performance of the entire blockchain can be effectively improved while the security of the entire blockchain is ensured.

In an embodiment, the second node is further configured for deleting the task data corresponding to the transaction task from the block database when the execution result is inconsistent with the state data.

Specifically, FIG. 11 is a flowchart of cleaning of expired data. When the secondary node determines that the new block reaches a consensus and submits the new block into the ledger, when an expired transaction ID exists in the expired transaction identification set (ExpireTxIDs) carried in a block header of the new block, the secondary node needs to clean expired data. A processing procedure is shown in FIG. 11. In the processing procedure shown in FIG. 11, when the block header of the new block carries the expired transaction identification set and the expired transaction ID exists in the expired transaction identification set (ExpireTxIDs), the secondary node may obtain corresponding transaction information according to the expired transaction ID in the expired transaction identification set and determine whether the transaction information is in a state data deletion mode (stateDB deletion mode). When the transaction information is in the state data deletion mode, the secondary node may obtain the execution result (key-value pair information) corresponding to the transaction task from the block database, obtain the state data (key-value pair information) corresponding to the transaction task at the current moment from the state database, and compare the execution result (key-value pair information) with the state data (key-value pair information) to obtain the comparison result. When the comparison result indicates that the execution result (key-value pair information) is inconsistent with the state data (key-value pair information), the secondary node may delete transaction content corresponding to the transaction task from the block database. To be specific, when the comparison result indicates that the execution result (key-value pair information) is inconsistent with the state data (key-value pair information), the secondary node may not delete the state data corresponding to the transaction task from the state database. To be specific, the blockchain system in this application may provide two modes of deleting or not deleting stateDB. Since stateDB needs to be used during subsequent contract execution, if data in the stateDB is deleted without considering any other relationship, an error may occur in an entire service. Therefore, the data in the stateDB is not deleted by default. However, the data in the stateDB may alternatively be deleted in some special scenarios. For example, in an evidence preservation scenario in which keys do not conflict. Since the keys do not conflict, the keys do not affect subsequent services, and the data in the stateDB may be deleted.

In this embodiment, to ensure security, in the mode in which the stateDB may be deleted, each node in the blockchain system also needs to determine whether a value corresponding to a current key is a value that is written currently. If the value is the value that is written currently, the data in the stateDB is deleted. If the value is not the value that is written currently, the data in the stateDB may not be deleted. In this way, security can be ensured to an extent, thereby effectively improving performance of the entire blockchain while ensuring the security of the entire blockchain.

In an embodiment, this application further provides an application scenario. The above data cleaning method for the blockchain is applied to the application scenario. Specifically, application of the data cleaning method for the blockchain in the application scenario is as follows:

When it is intended to complete cleaning of expired data during performing of consensus, the foregoing data cleaning method for the blockchain may be used. To be specific, in a blockchain system, when a first node serving as a primary node in a node cluster is configured for block generation, and the first node serving as the primary node builds a new block, the first node serving as the primary node determines an expired transaction task in a transaction deadline tree maintained by the first node, and extracts a preset quantity of transaction tasks from a transaction pool to obtain a preset quantity of target transaction tasks. The first node serving as the primary node may generate a proposal message of the new block based on the expired transaction task and the target transaction tasks. The proposal message carries transaction identification information of the expired transaction task. The first node serving as the primary node broadcasts the proposal message that carries transaction identification information of the expired transaction task to a secondary node in the blockchain to cause the secondary node to perform consensus on the new block based on the target transaction tasks and clean, after a consensus is reached, the expired transaction task based on the transaction identification information of the expired transaction task carried in the proposal message. Since a consensus is reached in the entire data cleaning process, and the process may be written into the blockchain, the data cleaning process may be completed while reaching a consensus, with high security and traceability. In addition, a level of data cleaning in the blockchain may alternatively be controlled to a transaction level. In this way, no error will occur even if services share the same chain. Therefore, performance of the entire blockchain can be effectively improved while the security of the entire blockchain is ensured.

The method according to this embodiment of this application may be applied to a consensus scenario of various blockchains. The data cleaning method for the blockchain provided in this embodiment of this application is described below by using a blockchain consensus scenario in a BFT consensus environment as an example.

With the development of technologies, a blockchain technology has become increasingly mature. Because of the characteristics of openness and transparency of the blockchain itself, more systems directly transfer services to the blockchain.

Essentially, a blockchain is a distributed storage system. Each node of the blockchain can store data, and the node stores data based on data. As a data volume increases, more and more data needs to be stored. Certainly, for some non-distributed data, storage performance of the blockchain gets lower and lower. Since the blockchain has distributed storage itself, each node usually uses a non-distributed database, and natural performance may be affected.

To improve overall processing performance, considering that not all pieces of data need to be used in the future, with reference to solutions in the current industry, this application provides a data cleaning solution that can be accurate to a transaction level based on a time stamp. Storage is effectively reduced through the solution, and most importantly, the cleaning process is automatically executed and receives a consensus.

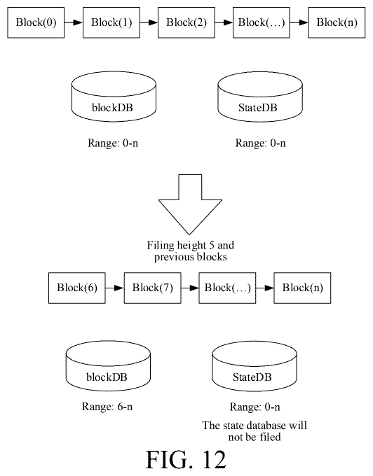

FIG. 12 is a schematic diagram showing data cleaning. A processing solution used in this manner is generally referred to as “data filing.” The so-called data filing is that an administrator of a blockchain system sends a command to nodes of an entire blockchain (the command is also sent to the blockchain in a transaction manner). The command can usually specify a height of a filing block, and the nodes of the blockchain can file all transaction data before the height, thereby reducing a data volume.

In the filing mode shown in FIG. 12, only data in a filing blockDB is filed, but data in a stateDB is not filed. The blockDB is a database that stores original transaction information. The stateDB is a database that stores a state. A state is a key-value pair of an operation in a transaction execution process. The stateDB processes repeated keys in a covering manner.

Data in the stateDB is not filed because there is no way to distinguish information of a key in the stateDB before a specified height (because a value of the key is covered). Secondly, since data in the stateDB is required in a transaction execution process, the data may not be randomly filed.

Defects of the above manner shown in FIG. 12 are as follows:

1. Filing cannot be automatically completed, and needs to be manually triggered by a person. Furthermore, the person is usually an administrator. This is a behavior that affects data.

2. Filed content cannot be distinguished at a transaction level, but only at a block level. This is not good for some transactions that are available but are just within a filing range. In addition, if a plurality of service systems are in one chain, a filing behavior may affect other services.

3. Filing is a single-point behavior, and cannot reach a consensus (or a consensus needs to be reached manually). Because the consensus is not reached, execution states may be inconsistent.

4. Data in the stateDB cannot be filed.

Therefore, to solve the above problems, this application provides an optimized solution, namely, a data cleaning method for a blockchain. In this optimized solution, a user may set expiration time for each transaction. At the expiration time, a blockchain system may delete the corresponding transaction (even including data in the stateDB) in a consensus manner. Therefore, a granularity of filing thereof is at a transaction level. Meanwhile, since filing is a consensus behavior, a consensus is reached.

On a product side, the method provided in this application can be applied to actual development of blockchain underlying software, or can be used as an external advertising mode, and can implement a code level according to the solution of this application, to optimize corresponding underlying blockchain codes.

On a technology side

### 1.1 Transaction Processing

To process a transaction when the transaction expires, expiration time needs to be defined in the transaction. The expiration time may be relative or absolute. If the expiration time is the relative time, time of creating the transaction is used as a start, as shown in FIG. 6. To be specific, a transaction filed in this application is certainly a transaction in a ledger. To process transaction filing more efficiently, in this application, a prefix tree structure and a time stamp are combined to define a transaction maintenance structure, namely, the structure of the transaction deadline tree shown in FIG. 4. In the structure shown in FIG. 4, the root node represents day; the second-level node represents hour; the third-level node represents minute; and the last leaf node includes a transaction ID list that needs to be cleaned at time represented by the third-level node corresponding to the leaf node.

To improve processing performance, it is generally recommended to maintain a relationship of a transaction deadline tree of a next day when a current day is about to end (for example, there is one hour left).

In this application, the process of creating the transaction deadline tree is shown in FIG. 7. A branch node having no data does not need to be created, so as to save memory.

### 1.2 Transaction Cleaning Procedure

A consensus algorithm in this embodiment of this application is a BFT consensus algorithm. This consensus algorithm generally includes several stages shown in FIG. 10.

A core of the method provided in this application is that a primary node needs to add a cleaned (filed) transaction ID into a proposal during proposing. The so-called proposal is generally a block plus node signature. To be specific, a cleaned transaction ID set needs to be added into a block. The information carried in the proposal message shown in FIG. 8 includes: ExpireTxRoot and ProposalTime are two necessary fields. The former is a MerkleRoot calculated for a transaction ID set that needs to be cleaned. The latter is mainly configured for determining a processing time range.

The information carried in the proposal message shown in FIG. 8 may alternatively include ExpireTxIDs that includes a transaction ID list to be deleted after the current consensus is reached. The proposal message may alternatively not include ExpireTxIDs. Usually, a transaction per second (TPS) of a blockchain system that does not include ExpireTxIDs is at a minute level, namely, each proposal has a minute interval of minute. In this way, the proposal can adapt to the transaction deadline tree created in this application. If a TPS of a system is at a high level, the proposal message needs to carry ExpireTxIDs, so that a transaction ID set that needs to be cleaned this time can be clearly confirmed.

Adjustment of the proposing process of the primary node is shown in FIG. 5. A core of the procedure shown in FIG. 5 is adding information such as ExpireTxRoot, ProposalTime, and ExpireTxIDs into the blockchain.

After a secondary node receives a proposal, a verification process of the secondary node is shown in FIG. 9. In the procedure shown in FIG. 9, the following points need to be particularly described:

1) Since a clock of each node is different, a time difference is allowed, but the time difference needs to be within a particular range, for example, within one minute.

2) If a block carries an expired transaction ID set, whether an ID of each expired transaction is valid needs to be verified. To be specific, whether the transaction is a to-be-cleaned transaction is determined. If the block does not carry the expired transaction ID set, each secondary node performs calculation according to a transaction deadline tree maintained in its own memory by using proposal time as a reference.

In the third stage of the BFT consensus, after receiving sufficient PreCommit, a node may perform a current consensus, to determine whether to discard this operation or submit the new block. When determining that the new block reaches a consensus and is submitted, the node needs to perform cleaning if there is content in ExpireTxIDs. A processing procedure is shown in FIG. 11. In the procedure shown in FIG. 11, several points need to be described:

1) The blockchain system in this application may provide two modes of deleting or not deleting stateDB. Since stateDB needs to be used during subsequent contract execution, if the stateDB is deleted without considering any other relationship, an error may occur in an entire service. Therefore, the data in the stateDB is not deleted by default. However, the data in the stateDB may alternatively be deleted in some special scenarios. For example, in an evidence preservation scenario in which keys do not conflict. Since the keys do not conflict, the keys do not affect subsequent services, and the data in the stateDB may be deleted.

2) To ensure security, even in the mode in which the stateDB may be deleted, the blockchain system also needs to determine whether a value corresponding to a current key is a value that is written currently. If the value is the value that is written currently, the data in the stateDB is deleted. In this way, security can be ensured to an extent although there is still A-B-A.

The technical solutions of this application have beneficial effects including:

1. A level of blockchain data cleaning may be controlled to a transaction level. In this way, no error will occur even if services share the same chain.

2. In the entire data cleaning process, a consensus is reached the process may be written into the blockchain, which has high security and traceability.

3. The cleaning process does not require manual participation, thereby improving overall efficiency.

4. Data in the stateDB can be cleaned to an extent, and more data can be cleaned than data cleaned in the conventional manner.

Although the operations are displayed sequentially according to the instructions of the arrows in the flowcharts of the embodiments, these operations are not necessarily performed sequentially according to the sequence instructed by the arrows. Unless otherwise explicitly specified in this application, execution of the operations is not strictly limited, and the operations may be performed in other sequences. Moreover, at least some operations in the flowchart involved in the above embodiments may include a plurality of operations or a plurality of stages. The operations or stages are not necessarily executed completely at the same moment and may be executed at different moments. The operations or stages are not necessarily sequentially executed, and may be executed alternately with other operations or at least some operations or stages of other operations.

Based on the same inventive concept, an embodiment of this application further provides a data cleaning apparatus for a blockchain, which is configured to implement the above data cleaning method for the blockchain. The implementation scheme provided by the apparatus to solve the problems is similar to the implementation scheme recorded in the above method. Therefore, for specific limitations in the one or more embodiments of the data cleaning apparatus for the blockchain provided below, refer to the limitations on the data cleaning method for the blockchain mentioned above, and will not be elaborated here.

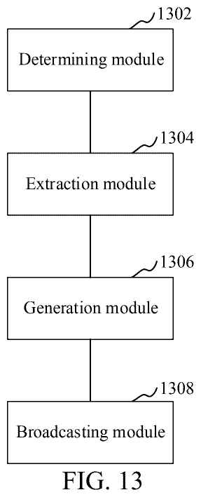

In an embodiment, as shown in FIG. 13, a data cleaning apparatus for a blockchain is provided, including: a determining module 1302, an extraction module 1304, a generation module 1306, and a broadcasting module 1308.

The determining module 1302 is configured to: obtain, when a new block is generated in the blockchain, a transaction deadline tree maintained by the first node, and determine an expired transaction task in the transaction deadline tree.

The extraction module 1304 is configured to extract a preset quantity of transaction tasks from a transaction pool of the blockchain, to obtain a preset quantity of target transaction tasks.

The generation module 1306 is configured to generate a proposal message of the new block based on the expired transaction task and the target transaction tasks, the proposal message carrying transaction identification information of the expired transaction task.

The broadcasting module 1308 is configured to broadcast the proposal message to a second node in the blockchain, the second node being configured for: performing consensus on the new block based on the target transaction tasks and cleaning the expired transaction task based on the transaction identification information after a consensus is reached.

In an embodiment, the apparatus further includes: an obtaining module, configured to obtain time of building the new block, to obtain first time. The determining module is further configured to determine the expired transaction task in the transaction deadline tree based on the first time.

In an embodiment, the preset quantity is at least two. The apparatus further includes: a creation module and a storage module. The creation module is configured to: obtain, after the new block reaches a consensus, blockchain identifications, transaction identification information, and transaction expiration time that are carried in the at least two target transaction tasks; and

generate a transaction deadline tree based on the blockchain identifications, the transaction identification information, and the transaction expiration time, a leaf node of the transaction deadline tree including the transaction identification information of the target transaction tasks. The storage module is configured to store the transaction identification information of the at least two target transaction tasks into the same leaf node when the transaction expiration time of the at least two target transaction tasks is the same.

In an embodiment, the transaction deadline tree includes a root node and an intermediate node. The intermediate node includes a second-level node and a third-level node. The creation module is further configured to create, based on the blockchain identifications, the transaction identification information, and the transaction expiration time, the root node on a daily basis, the second-level node at an hourly granularity, the third-level node at a minute granularity, and a leaf node corresponding to target time represented by the third-level node, the leaf node including the transaction identification information of a target transaction task that expires at the target time.

In an embodiment, the transaction identification information includes an expired transaction hash value, and the generation module 1306 is further configured to: determine an expired transaction identification set based on the expired transaction task; determine the expired transaction hash value according to the expired transaction identification set; add the expired transaction hash value into a block header of the new block; and generate the proposal message of the new block according to the block header and the target transaction tasks.

In an embodiment, the transaction identification information includes an expired transaction identification set, and the generation module 1306 is further configured to: determine the expired transaction identification set based on the expired transaction task; add the expired transaction identification set into a block header of the new block; and generate the proposal message of the new block according to the block header and the target transaction tasks.

In an embodiment, the transaction identification information includes an expired transaction identification set and an expired transaction hash value, and the generation module 1306 is further configured to: determine the expired transaction identification set based on the expired transaction task; determine the expired transaction hash value according to the expired transaction identification set; add the expired transaction identification set and the expired transaction hash value into a block header of the new block; and generate the proposal message of the new block according to the block header and the target transaction tasks.

In an embodiment, the proposal message carries the first time and the expired transaction hash value; the first time is time of building the new block; and the second node is further configured for: deserializing the proposal message to obtain processed proposal structure information; obtaining the first time from the proposal structure information; obtaining, when the first time is valid and the expired transaction identification set is not obtained, a local expired transaction task that satisfies the first time from a transaction deadline tree maintained by the second node; determining a hash value corresponding to the local expired transaction task; comparing the hash value with the expired transaction hash value to obtain a comparison result; generating negative vote information when the comparison result indicates that the hash value is inconsistent with the expired transaction hash value; and broadcasting the negative vote information to another node, the another node being a node in the blockchain system other than the second node.

In an embodiment, the second node is further configured for: obtaining the target transaction tasks from the proposal structure information in a case that the comparison result indicates that the hash value is consistent with the expired transaction hash value, and executing the target transaction tasks to obtain execution results corresponding to the target transaction tasks; and generating an affirmative vote message when the execution results are consistent with execution results carried in the proposal message, and broadcasting the affirmative vote message to the another node.

In an embodiment, the second node is further configured for: obtaining, in a case that the first time is valid and the expired transaction identification set is obtained, a local expired transaction task that satisfies the first time from the transaction deadline tree maintained by the second node; verifying the expired transaction identification set based on the local expired transaction task; and executing, when the verification succeeds, the operation of determining a hash value corresponding to the local expired transaction task.

In an embodiment, the second node is further configured for: generating a negative vote message in a case that the first time is not within a time threshold range, and broadcasting the negative vote message to the another node.

The second node is further configured for: determining a first PreCommit message based on a first Prevote message of the second node and a second Prevote message when the second Prevote message broadcast by another node has been received; determining, based on the first PreCommit message and the second PreCommit message when the second PreCommit message broadcast by the another node has been received, that the new block reaches a consensus, and writing the target transaction tasks and the execution results of the target transaction tasks into a local ledger; obtaining a corresponding transaction task according to the expired transaction identification set when the block header of the new block carries the expired transaction identification set; obtaining an execution result corresponding to the obtained transaction task from a block database, and obtaining state data corresponding to the obtained transaction task at a current moment from a state database; and when the execution result is consistent with the state data, deleting the state data corresponding to the transaction task from the state database and deleting task data corresponding to the transaction task from the block database.

In an embodiment, the second node is further configured for deleting the task data corresponding to the transaction task from the block database when the execution result is inconsistent with the state data.

The modules in the data cleaning apparatus for the blockchain may be implemented entirely or partially through software, hardware, or a combination thereof. The foregoing modules may be built in or independent of a processor of a computer device in a form of hardware, or may be stored in a memory of the computer device in a form of software, for the processor to invoke to execute operations corresponding to the foregoing modules.

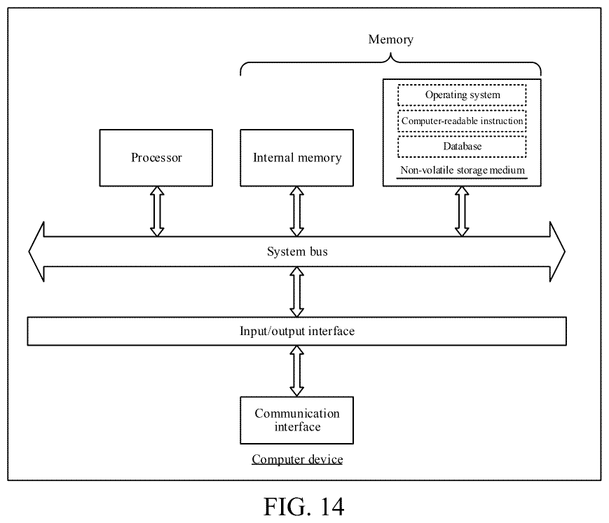

In an embodiment, a computer device is provided. The computer device may be a server, a diagram showing an internal structure of which can be as shown in FIG. 14. The computer device includes a processor, a memory, an input/output (I/O), and a communication interface. The processor, the memory, and the input/output interfaces are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium stores an operating system, a computer-readable instruction, and a database. The internal memory provides an environment for running of the operating system and the computer-readable instruction in the non-volatile storage medium. The database of the computer device is configured for storing block data and state data of a blockchain. The input/output interface of the computer device is configured to exchange information between the processor and an external device. The communication interface of the computer device is configured to connect and communicate with an external terminal through a network. The computer-readable instruction is executed by the processor to implement a data cleaning method for a blockchain.

A person skilled in the art can understand that the structure shown in FIG. 14 is merely a block diagram of a partial structure related to a solution in this application, and does not constitute a limitation on the computer device to which the solution in this application is applied. Specifically, the computer device may include more or fewer components than those shown in the figure, or some components may be combined, or a different component layout may be used.

In an embodiment, a computer device is provided. The computer device includes a memory and a processor, the memory having a computer-readable instruction stored therein, and the processor, when executing the computer-readable instruction, implementing the operations in the foregoing method embodiments.

In an embodiment, a computer-readable storage medium is provided, having a computer-readable instruction stored therein. The computer-readable instruction, when executed by a processor, implements the operations in the foregoing method embodiments.

In an embodiment, a computer program product is provided, including a computer-readable instruction. The computer-readable instruction, when executed by a processor, implements the operations in the foregoing method embodiments.

Here, user information (including, but not limited to, user equipment information, user personal information, and the like) and data (including, but not limited to, data for analysis, stored data, displayed data, and the like) involved in this application are all information and data authorized by users or fully authorized by all parties, and collection, use, and processing of relevant data need to comply with relevant laws, regulations, and standards of relevant countries and regions.

A person of ordinary skill in the art may understand that all or some of the procedures of the method in the foregoing embodiments may be implemented by the computer-readable instruction that instructs relevant hardware. The computer-readable instruction may be stored in a non-volatile computer-readable storage medium. When the computer-readable instruction is executed, the procedures of the foregoing method embodiments may be implemented. Any reference to a memory, a database or other media used in all the embodiments provided by this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory can include a random access memory (RAM), external cache memory, or the like. For the purpose of illustration rather than limitation, the RAM may be in various forms, such as a static random access memory (SRAM), or a dynamic random access memory (DRAM). The database involved in the embodiments of this application may include at least one of a relational database and a non-relational database. The non-relational database may include a blockchain-based distributed database, or the like, but is not limited thereto. The processor involved in the embodiments provided in this application may be a general-purpose processor, a central processing unit, a graphics processing unit, a digital signal processor, a programmable logic device, a quantum computing-based data processing logic device, or the like, but is not limited thereto.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A data cleaning method, performed by a computer device, comprising:
in response to a new block being generated in a blockchain including a first node maintained by the computer and a second node, obtaining a transaction deadline tree maintained by the first node, and determining an expired transaction task in the transaction deadline tree;
extracting one or more target transaction tasks from a transaction pool of the blockchain;
generating a proposal message of the new block based on the expired transaction task and the one or more target transaction tasks, the proposal message carrying transaction identification information of the expired transaction task; and
broadcasting the proposal message to the second node to cause the second node to perform consensus on the new block based on the one or more target transaction tasks and clean the expired transaction task based on the transaction identification information after consensus is reached.

2. The method according to claim 1, wherein determining the expired transaction task includes:
obtaining time of building the new block; and
determining the expired transaction task based on the time of building the new block.

3. The method according to claim 1,
wherein the one or more target transaction tasks include at least two target transaction tasks;
the method further comprising:
obtaining, after consensus is reached for the new block, blockchain identifications, transaction identification information, and transaction expiration times that are carried in the at least two target transaction tasks; and
generating, based on one or more of the blockchain identifications, the transaction identification information, and the transaction expiration time, one or more leaf nodes of the transaction deadline tree each including the transaction identification information of one or more of the at least two target transaction tasks, the transaction identification information of the at least two target transaction tasks being saved in a same one of the one or more leaf nodes when the transaction expiration time of the at least two target transaction tasks is same.

4. The method according to claim 3, further comprising:
creating, based on one or more of the blockchain identifications, the transaction identification information, and the transaction expiration time, a root node on a daily basis, a second-level node at an hourly granularity, and a third-level node at a minute granularity, of the transaction deadline tree;
wherein generating the one or more leaf nodes includes generating a leaf node corresponding to target time represented by the third-level node, the leaf node including the transaction identification information of one of the at least two target transaction tasks that expires at the target time.

5. The method according to claim 1, wherein:
the transaction identification information includes an expired transaction hash value; and
generating the proposal message includes:
determining an expired transaction identification set based on the expired transaction task;
determining the expired transaction hash value according to the expired transaction identification set;
adding the expired transaction hash value into a block header of the new block; and
generating the proposal message according to the block header and the one or more target transaction tasks.

6. The method according to claim 1, wherein:
the transaction identification information includes an expired transaction identification set; and
generating the proposal message includes:
determining the expired transaction identification set based on the expired transaction task;
adding the expired transaction identification set into a block header of the new block; and
generating the proposal message according to the block header and the one or more target transaction tasks.

7. The method according to claim 1, wherein:
the transaction identification information includes an expired transaction identification set and an expired transaction hash value; and
generating the proposal message includes:
determining the expired transaction identification set based on the expired transaction task;
determining the expired transaction hash value according to the expired transaction identification set;
adding the expired transaction identification set and the expired transaction hash value into a block header of the new block; and
generating the proposal message according to the block header and the one or more target transaction tasks.

8. The method according to claim 1, wherein:
the proposal message carries time of building the new block and an expired transaction hash value; and
the second node is further configured to deserialize the proposal message to obtain processed proposal structure information; and

9. The method according to claim 8, wherein the second node is further configured to:
obtain the time of building the new block from the proposal structure information;
in response to the time of building the new block being valid and the expired transaction identification set being not obtained, obtain, from a transaction deadline tree maintained by the second node, a local expired transaction task that satisfies the time of building the new block;
determine a hash value corresponding to the local expired transaction task;
compare the hash value with the expired transaction hash value to obtain a comparison result;
generate negative vote information in response to the comparison result indicating that the hash value is inconsistent with the expired transaction hash value; and
broadcast the negative vote information to other nodes in the blockchain.

10. The method according to claim 8, wherein the second node is further configured to:
obtain the one or more target transaction tasks from the proposal structure information in response to the comparison result indicating that the hash value is consistent with the expired transaction hash value;
execute the one or more target transaction tasks to obtain execution results corresponding to the one or more target transaction tasks;
generate an affirmative vote message in response to the execution results being consistent with execution results carried in the proposal message; and
broadcast the affirmative vote message to other nodes in the blockchain.

11. The method according to claim 8, wherein the second node is further configured to:
obtain the time of building the new block from the proposal structure information;
in response to the time of building the new block being valid and the expired transaction identification set being obtained, obtain, from the transaction deadline tree maintained by the second node, a local expired transaction task that satisfies the time of building the new block;
verify the expired transaction identification set based on the local expired transaction task; and
determine, in response to successfully verifying the expired transaction identification set, a hash value corresponding to the local expired transaction task.

12. The method according to claim 8, wherein the second node is further configured to:
obtain the time of building the new block from the proposal structure information;
generate a negative vote message in response to the time of building the new block being not within a time threshold range; and
broadcast the negative vote message to other nodes of the blockchain.

13. The method according to claim 1, wherein the second node is further configured to:
determine a first PreCommit message based on a first Prevote message of the second node and a second Prevote message broadcast by another node in response to receiving the when the second Prevote message;
in response to a second PreCommit message broadcast by the another node, determine, based on the first PreCommit message and the second PreCommit message, that consensus is reached for the new block, and write the one or more target transaction tasks and execution results of the one or more target transaction tasks into a local ledger;
in response to a block header of the new block carrying an expired transaction identification set, obtain a corresponding transaction task according to the expired transaction identification set, obtain an execution result corresponding to the obtained transaction task from a block database, and obtain state data corresponding to the obtained transaction task at a current moment from a state database; and
in response to the execution result being consistent with the state data, delete the state data corresponding to the transaction task from the state database and delete task data corresponding to the transaction task from the block database.

14. The method according to claim 13, wherein the second node is further configured to delete the task data corresponding to the transaction task from the block database in response to the execution result being inconsistent with the state data.

15. A computer device comprising:
a memory storing computer-readable instructions; and
a processor configured to execute the computer-readable instructions to:
in response to a new block being generated in a blockchain including a first node maintained by the computer device and a second node, obtain a transaction deadline tree maintained by the first node, and determine an expired transaction task in the transaction deadline tree;
extract one or more target transaction tasks from a transaction pool of the blockchain;
generate a proposal message of the new block based on the expired transaction task and the one or more target transaction tasks, the proposal message carrying transaction identification information of the expired transaction task; and
broadcast the proposal message to the second node to cause the second node to perform consensus on the new block based on the one or more target transaction tasks and clean the expired transaction task based on the transaction identification information after consensus is reached.

16. The computer device according to claim 15, wherein the processor is further configured to, when determining the expired transaction task:
obtain time of building the new block; and
determine the expired transaction task based on the time of building the new block.

17. The computer device according to claim 15, wherein:
the one or more target transaction tasks include at least two target transaction tasks; and
the processor is further configured to:
obtain, after consensus is reached for the new block, blockchain identifications, transaction identification information, and transaction expiration times that are carried in the at least two target transaction tasks; and
generate, based on one or more of the blockchain identifications, the transaction identification information, and the transaction expiration time, one or more leaf nodes of the transaction deadline tree each including the transaction identification information of one or more of the at least two target transaction tasks, the transaction identification information of the at least two target transaction tasks being saved in a same one of the one or more leaf nodes when the transaction expiration time of the at least two target transaction tasks is same.

18. The computer device according to claim 17, wherein the processor is further configured to:
create, based on one or more of the blockchain identifications, the transaction identification information, and the transaction expiration time, a root node on a daily basis, a second-level node at an hourly granularity, and a third-level node at a minute granularity, of the transaction deadline tree; and
when generating the one or more leaf nodes, generate a leaf node corresponding to target time represented by the third-level node, the leaf node including the transaction identification information of one of the at least two target transaction tasks that expires at the target time.

19. The computer device according to claim 15, wherein:
the transaction identification information includes an expired transaction hash value; and
the processor is further configured to, when generating the proposal message:
determine an expired transaction identification set based on the expired transaction task;
determine the expired transaction hash value according to the expired transaction identification set;
add the expired transaction hash value into a block header of the new block; and
generate the proposal message according to the block header and the one or more target transaction tasks.

20. A non-transitory computer-readable storage medium storing computer-readable instructions that, when executed by a processor, cause a computer having the processor to:
in response to a new block being generated in a blockchain including a first node maintained by the computer device and a second node, obtain a transaction deadline tree maintained by the first node, and determine an expired transaction task in the transaction deadline tree;
extract one or more target transaction tasks from a transaction pool of the blockchain;
generate a proposal message of the new block based on the expired transaction task and the one or more target transaction tasks, the proposal message carrying transaction identification information of the expired transaction task; and
broadcast the proposal message to the second node to cause the second node to perform consensus on the new block based on the one or more target transaction tasks and clean the expired transaction task based on the transaction identification information after consensus is reached.
